(19) United States
(12) Patent Application Publication
(10) Pub. No.: US 2009/0129373 A1
(43) Pub. Date: May 21, 2009

(54) EXTRACTION OF SUBSCRIBER TERMINAL INFORMATION SIGNAL

(76) Inventor: KAZUKI EGUCHI, Tokyo (JP)

Correspondence Address: NEC CORPORATION OF AMERICA, 6535 N. STATE HWY 161, IRVING, TX, 75039, US

(21) Appl. No.: 12/273,062

(22) Filed: Nov. 18, 2008

(30) Foreign Application Priority Data
Nov. 20, 2007 (JP) 2007-300376

(51) Int. Cl. H04L 12/66

(52) U.S. Cl. 370/352

(57) ABSTRACT

A first terminal sends a monitoring execution information for monitoring an information signal sent from a subscriber terminal, together with subscriber identification information, to a subscriber information storage apparatus. The subscriber information storage apparatus sends the subscriber identification information to a call control apparatus which is searched for based on the subscriber identification information. The call control apparatus sends the subscriber identification information to a network band managing apparatus which is searched for based on the subscriber identification information. The network band managing apparatus sends the subscriber identification information and a physical port number and a TCP/UDP port number which are searched for based on the subscriber identification information to a transmission apparatus which is searched for based on the subscriber identification information. The transmission apparatus extracts an information signal which uses the physical port represented by the physical port number and the TCP/UDP port represented by the TCP/UDP port number, and sends the extracted information signal together with the subscriber identification information to a second terminal.

This application is based upon and claims the benefit of priority from Japanese Patent Application No. 2007-300376 filed on Nov. 20, 2007, the content of which is incorporated by reference.

### BACKGROUND OF THE INVENTION

1. Field of the Invention

The present invention relates to an information communication system wherein a call control signal and an information signal such as an audio signal and a video signal are transmitted via different routes, a network band managing apparatus, a transmission apparatus, a method of monitoring an information signal in an information communication system, and a recording medium.

2. Description of the Related Art

In recent years, efforts have been directed to the standardization of a next generation network (NGN) which are to replace the existing telephone networks, at ITU-T (ITU-T Y.2012 “Functional requirements and architecture of the NGN”) and ETSI. The NGN makes it possible to provide a wide variety of services.

Service providing platforms for the NGN include IMS (IP Multimedia Subsystem) and MMD (Multi-Media Domain).

The IMS refers to a system which has been developed by a standardization body 3GPP (3GPP TS23.228 “IP Multimedia Subsystem (IMS); Stage 2”) and which is capable of providing various terminals such as cellular phones and terminals having a wireless LAN function with multimedia services using audio and video data independently of access networks to which the terminals are connected. JP-A No. 2007-251977 discloses a method of allowing a subscriber to access the IMS by comparing access network data used by the subscriber to access the IMS with preset access network data.

The MMD refers to a system which has been developed by a standardization body 3GPP2 (3GPP2 X.S0013-004 “IP Multimedia Call Control based on SIP and SDP; Stage 3”) and which is capable of providing various terminals with multimedia services using audio and video data independently of access networks to which the terminals are connected, as is the case with the IMS.

FIG. 1 of the accompanying drawings shows by way of example the configuration of an IMS/MMD system comprising BSs (Base Stations) 1002-1, 1002-2, APs (Access Points) 1003-1, 1003-2, AGWs (Access Gateways) 1004-1, 1004-2, NASSs (Network Attachment Subsystems) 1005-1, 1005-2, RACSs (Resource and Admission Control Subsystems)/PCRFs (Policy and Charging Rules Functions) 1006-1, 1006-2, CSCFs (Call Session Control Functions) 1007-1, 1007-2, and HSSs (Home Subscriber Servers) 1008-1, 1008-2. BS 1002-1 or AP 1003-1 and subscriber terminal 1001-1 are connected to each other by a wireless link. BS 1002-2 or AP 1003-2 and subscriber terminal 1001-2 are connected to each other by a wireless link.

BSs 1002-1, 1002-2 refer to wireless base stations that are connected respectively to subscriber terminals 1001-1, 1001-2 by wireless links.

AP 1003-1, AP 1003-2 refer to access points that are connected respectively to subscriber terminals 1001-1, 1001-2 by wireless links. Based on services to be provided, subscriber terminals 1001-1, 1001-2 are connected to either BSs 1002-1, 1002-2 or AP 1003-1, AP 1003-2.

AGWs 1004-1, 1004-2 are transmission apparatus that are connected to subscriber terminals 1001-1, 1001-2 through BSs 1002-1, 1002-2 or AP 1003-1, AP 1003-2, and send and receive information signals transmitted from subscriber terminals 1001-1, 1001-2 using ports represented by physical port numbers and TCP/UDP port numbers that are indicated by RACSs/PCRFs 1006-1, 1006-2.

NASSs 1005-1, 1005-2 are connected to a plurality of AGWs, authenticate subscriber terminals 1001-1, 1001-2, issue IP addresses, and perform a processing sequence for connecting subscriber terminals 1001-1, 1001-2 to the network.

RACSs/PCRFs 1006-1, 1006-2 are network band managing apparatus that are connected to a plurality of AGWs, manage bands for sending and receiving information signals, and indicate physical port numbers and TCP/UDP port numbers to AGWs 1004-1, 1004-2.

CSCFs 1007-1, 1007-2 are call control apparatus that are connected to a plurality of RACSs/PCRFs and establish calls according to call control signals which are sent respectively from subscriber terminals 1001-1, 1001-2.

HSSs 1008-1, 1008-2 are subscriber information storage apparatus that are connected to a plurality of CSCFs and store therein subscriber information which is representative of subscriber identification information for identifying subscriber terminals 1001-1, 1001-2 connected to the IMS/MMD system, and the contents of services to be provided to subscriber terminals 1001-1, 1001-2.

The information signals represent user data, other than call control signals for controlling calls, of signals that are sent from subscriber terminals 1001-1, 1001-2. In other words, the information signals represent audio signals and video signals that are sent and received.

In the IMS/MMD system thus constructed, a call control signal transmitted from subscriber terminal 1001-1 is sent to subscriber terminal 1001-2 through BS 1002-1 or AP 1003-1, AGW 1004-1, CSCF 1007-1, CSCF 1007-2, AGW 1004-2, and BS 1002-2 or AP 1003-2. The subscriber information of subscriber terminal 1001-1 is recognized by only HSSs 1008-1, 1008-2, CSCFs 1007-1, 1007-2, and RACSs/PCRFs 1006-1, 1006-2. An information signal is sent from subscriber terminal 1001-1 to subscriber terminal 1001-2 through BS 1002-1 or AP 1003-1, AGW 1004-1, AGW 1004-2, and BS 1002-2 or AP 1003-2. AGWs 1004-1, 1004-2 send information signals from physical ports and TCP/UDP ports thereof that are indicated by RACSs/PCRFs 1006-1, 1006-2.

For maintaining services using audio and video data, it is necessary to confirm how good the quality of audio and video data is during communications. It is the general practice to resort to a method of extracting (monitoring) information signals including audio signals and video signals during communications. The method also makes it possible to monitor an information signal of a desired subscriber if necessary.

In an information communication system wherein a call control signal and an information signal are transmitted via one route, an information signal sent from a subscriber terminal can be acquired by acquiring a call control signal sent from the subscriber terminal in order to monitor the information signal sent from the subscriber.

However, in an IP telephone system such as an IMS/MMD system wherein a call control signal and an information signal are transmitted via different routes, as described above, since AGW 1004-1 through which the information signal passes does not have the information of subscriber terminal 1001-1, AGW 1004-1 fails to identify the information signal depending on the subscriber. Consequently, the information signal of the desired subscriber cannot be extracted from AGW 1004-1.

### SUMMARY OF THE INVENTION

It is an object of the present invention to provide an information communication system which is capable of extracting an information signal of a desired subscriber though a call control signal and an information signal such as an audio signal and a video signal are transmitted via different routes in the information communication system, a network band managing apparatus, a transmission apparatus, a method of monitoring an information signal, and a recording medium.

To achieve the above object, there is provided in accordance with the present invention an information communication system comprising a plurality of transmission apparatus connected to a subscriber terminal carried by a subscriber, for sending and receiving an information signal sent from the subscriber terminal using a physical port and a TCP/UDP port, a plurality of network band managing apparatus connected to the transmission apparatus, for managing the band of the information signal and indicating the number of the physical port and the number of the TCP/UDP port to the transmission apparatus, a plurality of call control apparatus connected to the network band managing apparatus, for establishing a call according to a call control signal sent from the subscriber terminal, and a plurality of subscriber information storage apparatus connected to the call control apparatus, for storing subscriber identification information for identifying the subscriber terminal and contents of services to be provided to the subscriber terminal, the call control signal and the information signal passing through different routes, wherein the subscriber information storage apparatus are connected to a first terminal for sending an instruction to monitor the information signal and subscriber identification information for identifying the subscriber terminal to be monitored, and when the subscriber information storage apparatus receive the instruction sent from the first terminal, the subscriber information storage apparatus searches for one of the call control apparatus based on the subscriber identification information sent from the first terminal, and sends the instruction and the subscriber identification information to the call control apparatus which is searched for, wherein when the call control apparatus which is searched for receives the instruction, the call control apparatus searches for one of the network band managing apparatus based on the subscriber identification information sent from the subscriber information storage apparatus, and sends the instruction and the subscriber identification information to the network band managing apparatus which is searched for, wherein when the network band managing apparatus which is searched for receives the instruction, the network band managing apparatus searches for one of the transmission apparatus and the number of a physical port and the number of a TCP/UDP port used by the information signal, based on the subscriber identification information sent from the call control apparatus, and sends the instruction, the subscriber identification information, and the number of the physical port and the number of the TCP/UDP port which are searched for to the transmission apparatus which is searched for, and wherein when the transmission apparatus which is searched for receives the instruction, the transmission apparatus extracts an information signal which uses the physical port and the TCP/UDP port whose numbers are sent from the network band managing apparatus, and sends the extracted information signal and the subscriber identification information to a second terminal connected to the transmission apparatus.

According to the present invention, as described above, the first terminal sends the monitoring execution instruction for monitoring the information signal of the subscriber terminal, together with the subscriber identification information of the subscriber terminal to the subscriber information storage apparatus. Based on the subscriber identification information, the subscriber information storage apparatus searches for a call control apparatus, and sends the subscriber identification information to the call control apparatus which is searched for. Based on the subscriber identification information, the call control apparatus searched for a network band managing apparatus, and sends the subscriber identification information to the network band managing apparatus which is searched for. Based on the subscriber identification information, the network band managing apparatus searched for a transmission apparatus, a physical port number, and a TCP/UDP port number, and sends the subscriber identification information, the physical port number, and the TCP/UDP port number to the transmission apparatus which is searched for. The transmission apparatus extracts an information signal which uses the physical port represented by the physical port number and the TCP/UDP port number represented by the TCP/UDP port number, and sends the subscriber identification information and the extracted information to the second terminal connected to the transmission apparatus. Consequently, the information signal of a desired subscriber terminal can be extracted in the information communication system wherein the call control signal and the information signal pass through different routes.

The above and other objects, features, and advantages of the present invention will become apparent from the following description with reference to the accompanying drawings which illustrate an example of the present invention.

### BRIEF DESCRIPTION OF THE DRAWINGS

FIG. 1 is a block diagram showing by way of example the configuration of a general IMS/MMD system;

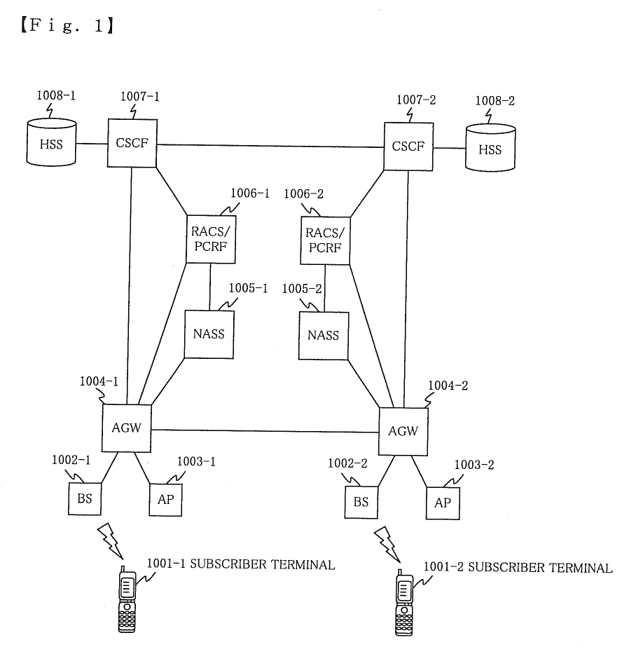

FIG. 2 is a block diagram of an information communication system according to an exemplary embodiment of the present invention;

FIG. 3 is a sequence diagram illustrative of a method of monitoring an information signal in the information communication system shown in FIG. 2;

FIG. 4 is a view showing by way of example a subscriber status list displayed on a maintenance terminal shown in FIG. 2;

FIG. 5 is a diagram showing by way of example information representing an association between subscriber IDs and CSCF numbers that is stored in an HSS shown in FIG. 2;

FIG. 6 is a diagram showing by way of example information representing an association between subscriber IDs and RACS/PCRF numbers that is stored in CSCFs shown in FIG. 2;

FIG. 7 is a diagram showing by way of example information representing an association between subscriber IDs, AGW numbers, physical port numbers, and TCP/UDP port numbers that is stored in RACSs/PCRFs shown in FIG. 2;

FIG. 8 is a block diagram showing by way of example the configuration of an AGW shown in FIG. 2;

FIG. 9 is a view showing by way of example an image displayed on a monitor terminal when a subscriber ID and an information signal are reproduced; and

FIG. 10 is a diagram showing by way of example a Diameter signal format.

### DESCRIPTION OF THE EXEMPLARY EMBODIMENT

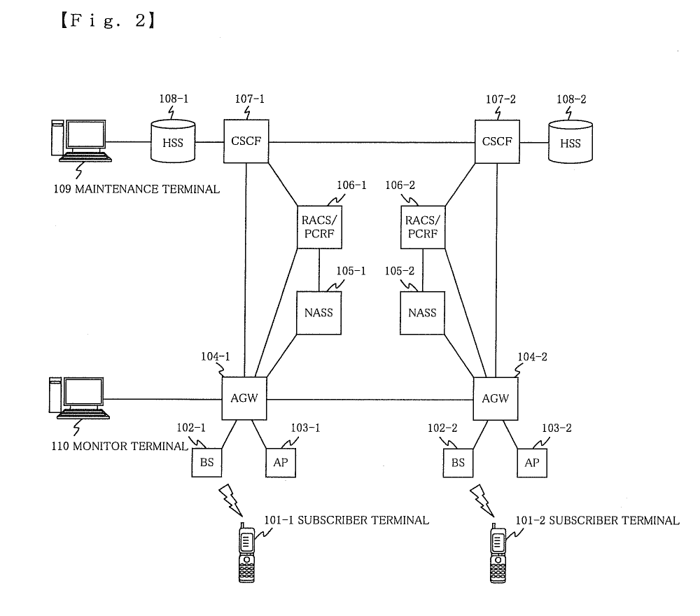

FIG. 2 shows in block form an information communication system according to an exemplary embodiment of the present invention. As shown in FIG. 2, the information communication system comprises BSs (Base Stations) 102-1, 102-2, APs (Access Points) 103-1, 103-2, AGWs (Access Gateways) 104-1, 104-2, NASSs (Network Attachment Subsystems) 105-1, 105-2, RACSs (Resource and Admission Control Subsystems)/PCRFs (Policy and Charging Rules Functions) 106-1, 106-2, CSCFs (Call Session Control Functions) 107-1, 107-2, and HSSs (Home Subscriber Servers) 108-1, 108-2. These components are connected in a mesh structure. BS 102-1 or AP 103-1 and subscriber terminal 101-1 are connected to each other by a wireless link. BS 102-2 or AP 103-2 and subscriber terminal 101-2 are connected to each other by a wireless link. Maintenance terminal 109 is connected to HSS 108-1. Monitor terminal 110 is connected to AGW 104-1. The information communication system is used in an IP telephone system such as an IMD/MMD system wherein a call control signal and an information signal are transmitted via different routes.

HSS 108-1 and maintenance terminal 109 may be connected to each other through a network or may be directly connected to each other. AGW 104-1 and monitor terminal 110 may be connected to each other through a network or may be directly connected to each other. Maintenance terminal 109 and monitor terminal 110 may be the same terminal. In other words, maintenance terminal 109 and monitor terminal 110 may be one terminal which has the function of maintenance terminal 109 and the function of monitor terminal 110.

BSs 102-1, 102-2 refer to wireless base stations that are connected respectively to subscriber terminals 101-1, 101-2 by wireless links.

AP 103-1, AP 103-2 refer to access points that are connected respectively to subscriber terminals 101-1, 101-2 by wireless links. Based on services to be provided, subscriber terminals 101-1, 101-2 are connected to either BSs 102-1, 102-2 or AP 103-1, AP 103-2.

AGWs 104-1, 104-2 are transmission apparatus that are connected to subscriber terminals 101-1, 101-2 through BSs 102-1, 102-2 or AP 103-1, AP 103-2, and send and receive information signals transmitted from subscriber terminals 101-1, 101-2 using ports represented by physical port numbers and TCP/UDP port numbers that are indicated by RACSs/PCRFs 106-1, 106-2.

NASSs 105-1, 105-2 are connected to a plurality of AGWs, authenticate subscriber terminals 101-1, 101-2, issue IP addresses, and perform a processing sequence for connecting subscriber terminals 101-1, 101-2 to the network.

RACSs/PCRFs 106-1, 106-2 are network band managing apparatus that are connected to a plurality of AGWs, control bands for sending and receiving information signals, and indicate physical port numbers and TCP/UDP port numbers to AGWs 104-1, 104-2.

CSCFs 107-1, 107-2 are call control apparatus that are connected to a plurality of RACSs/PCRFs and establish calls according to call control signals which are sent respectively from subscriber terminals 101-1, 101-2.

HSSs 108-1, 108-2 are subscriber information storage apparatus that are connected to a plurality of CSCFs and store therein subscriber information which is representative of subscriber identification information for identifying subscriber terminals 101-1, 101-2 connected to the IMS/MMD system, and the contents of services to be provided to subscriber terminals 101-1, 101-2. HSSs 108-1, 108-2 also store therein subscriber information such as positional information of subscriber terminals 101-1, 101-2.

Maintenance terminal 109 is a first terminal for instructing HSS 108-1 to monitor information signals sent to any desired subscriber terminal 101-1. Maintenance terminal 109 may also serve as a maintenance terminal for writing subscriber information in HSS 108-1.

Monitor terminal 110 is a second terminal for storing or reproducing monitored information signals.

The information signals represent user data, other than call control signals for controlling calls, of signals that are sent from subscriber terminals 101-1, 101-2. In other words, the information signals represent audio signals and video signals that are sent and received.

In the IMS/MMD system thus constructed, a call control signal transmitted from subscriber terminal 101-1 is sent to subscriber terminal 101-2 through BS 102-1 or AP 103-1, AGW 104-1, CSCF 107-1, CSCF 107-2, AGW 104-2, and BS 102-2 or AP 103-2. The subscriber information of subscriber terminal 101-1 is recognized by only HSSs 108-1, 108-2, CSCFs 107-1, 107-2, and RACSs/PCRFs 106-1, 106-2. An information signal is sent from subscriber terminal 101-1 to subscriber terminal 101-2 through BS 102-1 or AP 103-1, AGW 104-1, AGW 104-2, and BS 102-2 or AP 103-2.

When subscriber terminals 101-1, 101-2 are recognized as being connected, RACSs/PCRFs 106-1, 106-2 search the physical ports and TCP/UDP ports of AGWs 104-1, 104-2 for idle ports, and send the ports of idle physical ports and TCP/UDP ports that are found to AGWs 104-1, 104-2. AGWs 104-1, 104-2 now send and receive information signals using the ports of the physical port numbers and TCP/UDP port numbers that are sent from RACSs/PCRFs 106-1, 106-2.

Subscriber terminals 101-1, 101-2 may be fixed terminals. Fixed subscriber terminals 101-1, 101-2 are connected respectively to AGWs 104-1, 104-2 through wires.

In FIG. 2, the information communication system is shown as having two BSs 102-, 102-2, two APs 103-1, 103-2, two AGWs 104-1, 104-2, two NASSs 105-1, 105-2, two RACSs/PCRFs 106-1, 106-2, two CSCFs 107-1, 107-2, and two HSSs 108-1, 108-2 for illustrative purposes. However, it is general for the information communication system to have three or more BSs, three or more APs, three or more AGWs, three or more NASSs, three or more RACSs/PCRFs, three or more CSCFs, and three or more HSSs.

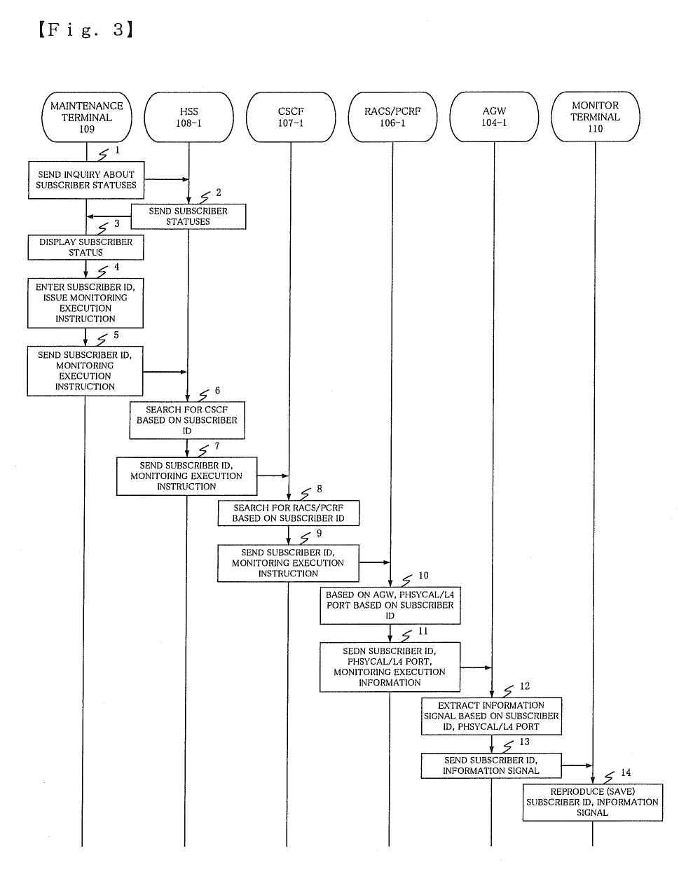

A method of monitoring an information signal in the information communication system shown in FIG. 2 will be described below with reference to FIG. 3.

When the maintenance person sends an inquiry about subscriber statuses to HSS 108-1 using maintenance terminal 109 in step 1, HSS 108-1 sends subscriber statuses in step 2. The maintenance person may make an inquiry using a certain instruction from maintenance terminal 109 that is connected to HSS 108-1, and no specific inquiry method will be defined here. An inquiry signal may be of any type insofar as it can be recognized by maintenance terminal 109 and HSS 108-1, and no specific inquiry signal format will be defined here.

When the subscriber statuses sent from HSS 108-1 are received by maintenance terminal 109, maintenance terminal 109 displays a list of the subscriber statuses in step 3.

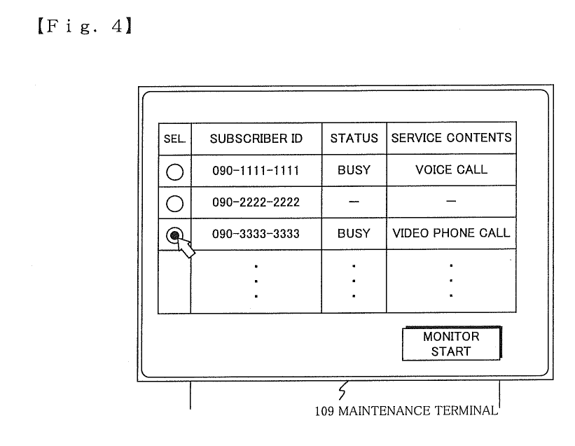

As shown in FIG. 4, maintenance terminal 109 shown in FIG. 2 displays subscriber IDs representing identifiable subscriber terminal identification information assigned to the subscriber terminals, statuses of the subscriber terminals, and service contents that can be received by the subscriber terminals, in association with each other.

For example, maintenance terminal 109 displays subscriber ID “090-1111-1111”, status “BUSY”, and service contents “VOICE CALL” in association with each other. This displayed information indicates that the subscriber terminal whose subscriber ID is “090-1111-1111” is busy at the moment and can receive a voice call service. Maintenance terminal 109 also displays subscriber ID “090-2222-2222”, but not any status and any service contents in association therewith. This displayed information indicates that the subscriber terminal whose subscriber ID is “090-2222-2222” is positionally registered, but has not started a call. Maintenance terminal 109 also displays subscriber ID “090-3333-3333”, status “BUSY”, and service contents “VIDEO PHONE CALL” in association with each other. This displayed information indicates that the subscriber terminal whose subscriber ID is “090-3333-3333” is busy at the moment and can receive a video phone service.

The telephone numbers and service contents referred to above are shown for illustrative purposes only and do not represent any existing telephone numbers and service contents.

The list of the subscriber statuses displayed on maintenance terminal 109 is stored in HSS 108-1 with the subscriber statuses being associated with each other.

The subscriber's telephone numbers have been described as the subscriber IDs in the above example. However, any other subscriber terminal identification information specific to the subscribers may be used as the subscriber ID insofar as it can identify the subscriber terminals. For example, identification information such as e-mail addresses or URLs (Uniform Resource Locators) allocated to the subscriber terminals may be used as the subscriber ID.

Maintenance terminal 109 also displays options for selecting subscriber terminals in addition to the subscriber statuses. For example, as shown in FIG. 4, maintenance terminal 109 displays radio buttons associated with the respective subscriber IDs. When the maintenance person selects either one of the displayed radio buttons, the subscriber terminal having the subscriber terminal associated with the selected radio button is recognized as a subscriber terminal to be monitored. Maintenance terminal 109 may alternatively display check boxes rather than the radio buttons, so that the maintenance person can select one of the check boxes which is associated with the subscriber ID of a desired subscriber terminal. Further alternatively, maintenance terminal 109 may allow the maintenance person to click on the subscriber ID of a desired subscriber terminal to select the subscriber ID, thus recognizing the subscriber terminal having the selected subscriber ID as a subscriber terminal to be monitored.

As shown in FIG. 4, maintenance terminal 109 also displays a button for indicating a timing to start monitoring the information signal of a selected subscriber terminal.

When a desired subscriber terminal is selected as described above, maintenance terminal 109 issues a monitoring execution instruction in step 4. Maintenance terminal 109 sends the monitoring execution instruction to HSS 108-1 in step 5. At this time, the selected ID is sent together with the monitoring execution instruction to HSS 108-1.

When a desired subscriber terminal is selected from the list displayed on maintenance terminal 109 or when the button for indicating a timing to start monitoring the information signal of a selected subscriber terminal is clicked on, the monitoring execution instruction may be executed. The time at which the monitoring execution instruction is to be executed, i.e., the time at which the information signal of the selected subscriber terminal is to be monitored, may be specified, i.e., reserved. Specifically, maintenance terminal 109 displays a column for entering monitoring start times in addition to the list of the subscriber statuses displayed in step 3 as shown in FIG. 4. When the maintenance person enters a monitoring start time in the column in connection with the selected subscriber terminal, the time at which the monitoring execution instruction is to be executed is specified or reserved.

When the monitoring execution instruction and the subscriber ID sent from maintenance terminal 109 are received and verified by HSS 108-1, CSCF 107-1 is searched for based on the subscriber ID in step 6. HSS 108-1 can verify the monitoring execution instruction by checking whether the monitoring execution instruction has a predetermined signal format established therefor or not. As described above, the information communication system is of a mesh structure with a plurality of CSCFs being connected to HSS 108-1. The CSCFs that are connected to HSS 108-1 are searched for CSCF 107-1 which is processing a call control signal from subscriber terminal 101-1 at the time of establishing a call.

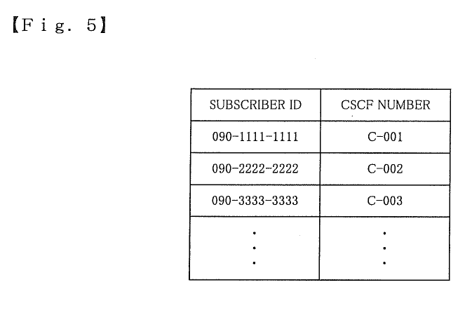

As shown in FIG. 5, HSS 108-1 shown in FIG. 2 stores therein subscriber IDs and CSCF numbers in association with each other.

The subscriber IDs stored in HSS 108-1 are identical to those displayed on maintenance terminal 109. The CSCF numbers refer to numbers (identification information) that are identifiably assigned to the respective CSCFs connected to HSS 108-1.

As shown in FIG. 5, HSS 108-1 stores therein subscriber ID “090-1111-1111” and CSCF number “C-001” in association with each other. This stored information indicates that the number of a CSCF which processes a call control signal from the subscriber terminal whose subscriber ID is “090-1111-1111” is “C-001”. HSS 108-1 also stores therein subscriber ID “090-2222-2222” and CSCF number “C-002” in association with each other. This stored information indicates that the number of a CSCF which processes a call control signal from the subscriber terminal whose subscriber ID is “090-2222-2222” is “C-002”. HSS 108-1 also stores therein subscriber ID “090-3333-3333” and CSCF number “C-003” in association with each other. This stored information indicates that the number of a CSCF which processes a call control signal from the subscriber terminal whose subscriber ID is “090-3333-3333” is “C-003”.

For example, if the subscriber ID sent together with the monitoring execution instruction is “090-3333-3333”, then a CSCF having CSCF number “C-003” is searched for. It is assumed that the CSCF having CSCF number “C-003” is CSCF 107-1 shown in FIG. 2.

When CSCF 107-1 is searched for based on the subscriber ID, the monitoring execution instruction and the subscriber ID are sent to CSCF 107-1 in step 7.

The monitoring execution instruction and the subscriber ID sent from HSS 108-1 to CSCF 107-1 are received by CSCF 107-1. If the monitoring execution instruction received by CSCF 107-1 is verified, then RACS/PCRF 106-1 is searched for based on the received subscriber ID in step 8. CSCF 107-1 can verify the monitoring execution instruction by checking whether the monitoring execution instruction has a predetermined signal format established therefor or not. As described above, the information communication system is of a mesh structure with a plurality of RACSs/PCRFs being connected to CSCF 107-1. The RACSs/PCRFs that are connected to CSCF 107-1 are searched for RACS/PCRF 106-1 which is controlling the band used by subscriber terminal 101-1 at the time of establishing a call.

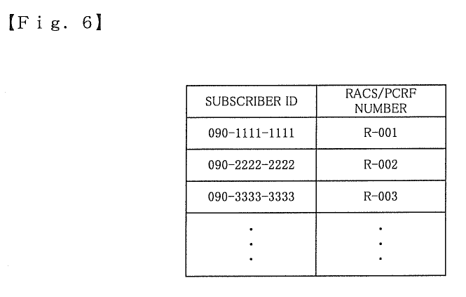

As shown in FIG. 6, CSCF 107-1 shown in FIG. 2 stores therein subscriber IDs and RACS/PCRF numbers in association with each other.

The subscriber IDs stored in CSCF 107-1 are identical to those displayed on maintenance terminal 109. The RACS/PCRF numbers refer to numbers (identification information) that are identifiably assigned to the respective RACSs/PCRFs connected to CSCF 107-1.

As shown in FIG. 6, CSCF 107-1 stores therein subscriber ID “090-1111-1111” and RACS/PCRF number “R-001” in association with each other. This stored information indicates that the number of an RACS/PCRF which controls the band used by the subscriber terminal whose subscriber ID is “090-1111-1111” is “R-001”. CSCF 107-1 also stores therein subscriber ID “090-2222-2222” and RACS/PCRF number “R-002” in association with each other. This stored information indicates that the number of an RACS/PCRF which controls the band used by the subscriber terminal whose subscriber ID is “090-2222-2222” is “R-002”. CSCF 107-1 also stores therein subscriber ID “090-3333-3333” and RACS/PCRF number “R-002” in association with each other. This stored information indicates that the number of an RACS/PCRF which controls the band used by the subscriber terminal whose subscriber ID is “090-3333-3333” is “R-003”.

For example, if the subscriber ID sent together with the monitoring execution instruction is “090-3333-3333”, then an RACS/PCRF having RACS/PCRF number “R-003” is searched for. It is assumed that the RACS/PCRF having RACS/PCRF number “R-003” is RACS/PCRF 106-1 shown in FIG. 2.

When RACS/PCRF 106-1 is searched for based on the subscriber ID, the monitoring execution instruction and the subscriber ID are sent to RACS/PCRF 106-1 in step 9.

The monitoring execution instruction and the subscriber ID sent from CSCF 107-1 to RACS/PCRF 106-1 are received by RACS/PCRF 106-1. If the monitoring execution instruction received by RACS/PCRF 106-1 is verified, then AGW 104-1, a physical port number, and a TCP/UDP port number are searched for based on the received subscriber ID in step 10. RACS/PCRF 106-1 can verify the monitoring execution instruction by checking whether the monitoring execution instruction has a predetermined signal format established therefor or not. As described above, the information communication system is of a mesh structure with a plurality of AGWs being connected to RACS/PCRF 106-1. The AGWs that are connected to RACS/PCRF 106-1 are searched for AGW 104-1 through which the information signal sent from subscriber terminal 101-1 passes. The numbers of the physical ports and the TCP/UDP ports of AGW 104-1 are searched for the numbers of a physical port and a TCP/UDP port for sending and receiving the information signal from subscriber terminal 101-1. The numbers that are searched for may be the numbers of a physical port and a TCP/UDP port through which the information signal sent from subscriber terminal 101-1 is received by AGW 104-1. Alternatively, the numbers that are searched for may be the numbers of a physical port and a TCP/UDP port through which the information signal sent from subscriber terminal 101-1 and received by AGW 104-1 is sent to AGW 104-2. These numbers of a physical port and a TCP/UDP port represent the numbers of an idle physical port and an idle TCP/UDP port of AGW 104-1 which are searched for and determined by RACS/PCRF 106-1 at the time of establishing a call.

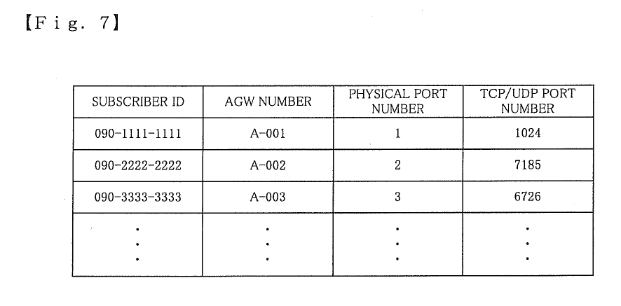

As shown in FIG. 7, RACS/PCRF 106-1 shown in FIG. 2 stores therein subscriber IDs, AGW numbers, physical port numbers, and TCP/UDP port numbers in association with each other. These items of associated information are stored in RACS/PCRF 106-1 at the time of establishing a call.

The subscriber IDs stored in RACS/PCRF 106-1 are identical to those displayed on maintenance terminal 109. The AGW numbers refer to numbers (identification information) that are identifiably assigned to the respective AGWS connected to RACS/PCRF 106-1. The physical port numbers refer to the numbers of the L1 ports of the physical layers of the respective AGWs. The TCP/UDP port numbers refer to the numbers of the L4 ports of the transport layers of the respective AGWs.

As shown in FIG. 7, RACS/PCRF 106-1 stores therein subscriber ID “090-1111-1111”, AGW number “A-001”, physical port number “1”, and TCP/UDP port number “1024” in association with each other. This stored information indicates that the number of the AGW for sending the information signal of the subscriber number whose subscriber ID is “090-1111-1111” is “A-001”, the physical port number of the AGW is “1”, and the TCP/UDP port number thereof is “1024”. RACS/PCRF 106-1 also stores therein subscriber ID “090-2222-2222”, AGW number “A-002”, physical port number “2”, and TCP/UDP port number “7185” in association with each other. This stored information indicates that the number of the AGW for sending the information signal of the subscriber number whose subscriber ID is “090-2222-2222” is “A-002”, the physical port number of the AGW is “2”, and the TCP/UDP port number thereof is “7185”. RACS/PCRF 106-1 also stores therein subscriber ID “090-3333-3333”, AGW number “A-003”, physical port number “3”, and TCP/UDP port number “6726” in association with each other. This stored information indicates that the number of the AGW for sending the information signal of the subscriber number whose subscriber ID is “090-3333-3333” is “A-003”, the physical port number of the AGW is “3”, and the TCP/UDP port number thereof is “6726”.

For example, if the subscriber ID sent with the monitoring execution instruction is “090-3333-3333”, then an AGW whose AGW number is “A-003” is searched for, and physical port number “3” and TCP/UDP port number “6726” are also searched for. It is assumed that the ATW having AGW number “A-003” is AGW 104-1 shown in FIG. 2.

When AGW 104-1, the physical port number, and the TCP/UDP port number are searched for based on the subscriber ID, the monitoring execution instruction, the subscriber ID, the physical port number, and the TCP/UDP port number that are searched for are sent from RACS/PCRF 106-1 to AGW 104-1 in step 11.

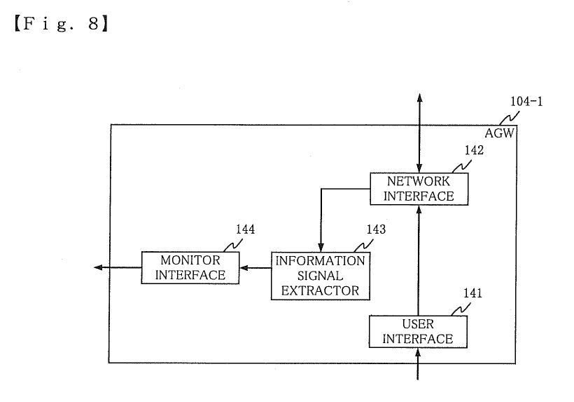

As shown in FIG. 8, AGW 104-1 shown in FIG. 2 comprises user interface 141, network interface 142, information signal extractor 143, and monitor interface 144.

User interface 141 is connected to BS 102-1 and AP 103-1, and sends and receives a call control signal and an information signal to and from subscriber terminal 101 through BS 102-1 or AP 103-1.

Network interface 142 is connected to NASS 105-1, RACS/PCRF 106-1, and CSCF 107-1, and sends and receives a call control signal to and from NASS 105-1, RACS/PCRF 106-1, and CSCF 107-1. Network interface 142 is also connected to AGW 104-2 through a given physical port and a given TCP/UDP port, and sends and receives an information signal to and from AGW 104-2.

Information signal extractor 143 recognizes the monitoring execution information from a signal received by network interface 142. When information signal extractor 143 recognizes the monitoring execution information, it extracts (copies) an information signal sent from AGW 104-1 based on a physical port number and TCP/UDP port number received by network interface 142.

Monitor interface 144 sends the information signal extracted by information signal extractor 142 to monitor terminal 110.

The components shown in FIG. 8 are only those which have a bearing on the present invention. AGW 104-2 shown in FIG. 2 is of a configuration that is identical to the configuration of AGW 104-1 shown in FIG. 8.

When the monitoring execution instruction, the subscriber ID, the physical port number, and the TCP/UDP port number are sent from RACS/PCRF 106-1 to AGW 104-1 in step 11, they are received by network interface 142 of AGW 104-1. Information extractor 142 recognizes the monitoring execution instruction, and extracts (copies) the information signal sent from subscriber terminal 101-1 using the physical port and the TCP/UDP port which are represented by the physical port number and the TCP/UDP port number that are received in step 12.

Specifically, if the physical port number and the TCP/UDP port number representing the physical port and the TCP/UDP port via which the information signal sent from subscriber terminal 101-1 is received are searched for, then the information signal received through the ports represented by these port numbers is extracted. Alternatively, if the physical port number and the TCP/UDP port number representing the physical port and the TCP/UDP port via which the information signal sent from subscriber terminal 101-1 is sent from AGW 104-1 are searched for, then the information signal sent through the ports represented by these port numbers is extracted.

When information extractor 143 extracts the information signal, the extracted information signal is sent, together with the subscriber ID received by network interface 142, from monitor interface 144 to monitor terminal 110 in step 13.

When the subscriber ID and the information signal are sent from AGW 104-1 to monitor terminal 110, monitor terminal 110 reproduces the subscriber ID and the information signal in step 14. At the same time monitor terminal 110 reproduces the subscriber ID and the information signal, monitor terminal 110 may store the subscriber ID and the information signal therein. Alternatively, monitor terminal 110 may not reproduce the subscriber ID and the information signal, but may only store the subscriber ID and the information signal therein.

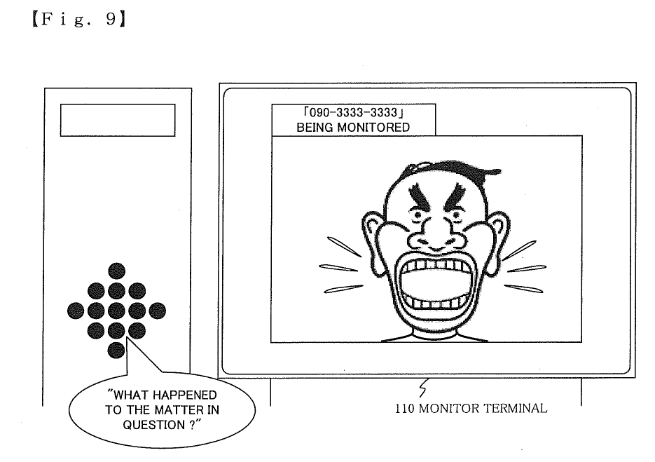

As shown in FIG. 9, monitor terminal 110 reproduces subscriber ID “090-3333-3333”, a video signal and an audio signal which are represented by the information signal. The information signal sent from subscriber terminal 101-1 can now be confirmed on monitor terminal 110.

The signal format of monitoring execution instructions that are sent and received between the various components may use usable fields according to existing SIP/Diameter/MEGACO IF, and is not limited to any particular details.

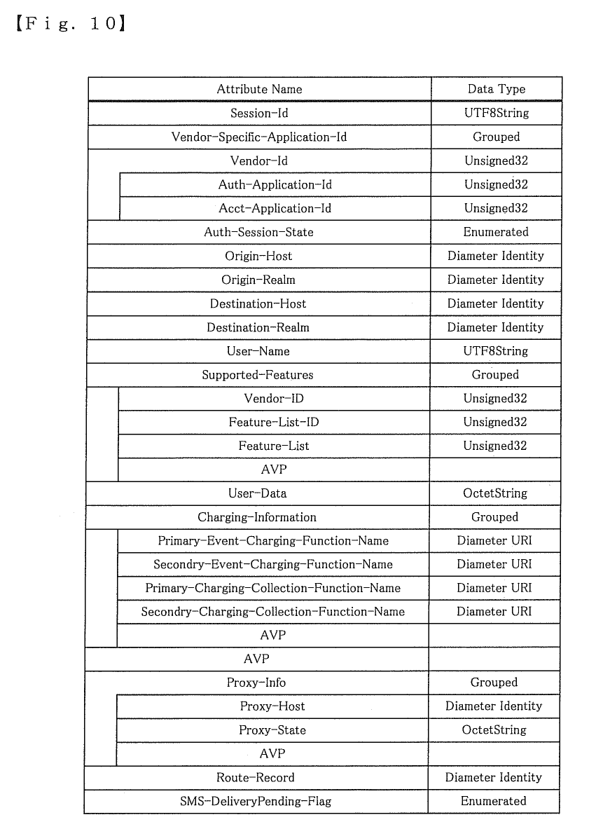

Signals of Diameter have fields determined as shown in FIG. 10, and a field whose attribute name is “User-Data” as shown in FIG. 10 can be used. By inserting a monitoring execution instruction into “User-Data” in a predetermined format, each of the components is able to recognize the monitoring execution instruction. The signal format of Diameter is standardized according to RFC 3588 issued by IETF. Rather than Diameter, fields which can use existing signals may be used.

The processing sequences of RACS/PCRF 106-1 and AGW 104-1 shown in FIG. 3 may be performed by logic circuits constructed therefor. Alternatively, programs descriptive of the processing sequences may be recorded in a recording medium that can be read by RACS/PCRF 106-1 and AGW 104-1, and the program recorded in the recording medium may be read and executed by RACS/PCRF 106-1 and AGW 104-1. The recording medium that can be read by RACS/PCRF 106-1 and AGW 104-1 may comprise a removable recording medium such as a floppy disk (registered trademark), a magnetooptical disk, a DVD, a CD, or the like, or an HDD or the like mounted in RACS/PCRF 106-1 and AGW 104-1. The program recorded in the recording medium is read by CPUs (not shown) of RACS/PCRF 106-1 and AGW 104-1 and executed thereby to perform processing sequences similar to the above processing sequences. Each of the CPUs operates as a computer for executing the program that is read from the above recording medium.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An information communication system comprising:
a plurality of transmission apparatus connected to a subscriber terminal carried by a subscriber, for sending and receiving an information signal sent from the subscriber terminal using a physical port and a TCP/UDP port;
a plurality of network band managing apparatus connected to said transmission apparatus, for managing the band of said information signal and indicating the number of said physical port and the number of said TCP/UDP port to said transmission apparatus;
a plurality of call control apparatus connected to said network band managing apparatus, for establishing a call according to a call control signal sent from said subscriber terminal; and
a plurality of subscriber information storage apparatus connected to said call control apparatus, for storing subscriber identification information for identifying said subscriber terminal and contents of services to be provided to said subscriber terminal, said call control signal and said information signal passing through different routes;
wherein said subscriber information storage apparatus are connected to a first terminal for sending an instruction to monitor said information signal and subscriber identification information for identifying the subscriber terminal to be monitored, and when said subscriber information storage apparatus receive said instruction sent from said first terminal, said subscriber information storage apparatus searches for one of said call control apparatus based on said subscriber identification information sent from said first terminal, and sends said instruction and said subscriber identification information to the call control apparatus which is searched for;
wherein when said call control apparatus which is searched for receives said instruction, said call control apparatus searches for one of said network band managing apparatus based on said subscriber identification information sent from said subscriber information storage apparatus, and sends said instruction and said subscriber identification information to the network band managing apparatus which is searched for;
wherein when said network band managing apparatus which is searched for receives said instruction, said network band managing apparatus searches for one of said transmission apparatus and the number of a physical port and the number of a TCP/UDP port used by said information signal, based on said subscriber identification information sent from said call control apparatus, and sends said instruction, said subscriber identification information, and the number of the physical port and the number of the TCP/UDP port which are searched for to the transmission apparatus which is searched for; and
wherein when said transmission apparatus which is searched for receives said instruction, said transmission apparatus extracts an information signal which uses the physical port and the TCP/UDP port whose numbers are sent from said network band managing apparatus, and sends the extracted information signal and said subscriber identification information to a second terminal connected to said transmission apparatus.

2. An information communication system according to claim 1, wherein when said network band managing apparatus which is searched for receives said instruction, said network band managing apparatus searches for one of said transmission apparatus and the number of a physical port and the number of a TCP/UDP port through which said information signal is sent from the transmission apparatus which is searched for, based on said subscriber identification information sent from said call control apparatus; and
wherein when said transmission apparatus which is searched for receives said instruction, said transmission apparatus extracts an information signal sent from the physical port and the TCP/UDP port whose numbers are sent from said network band managing apparatus.

3. An information communication system according to claim 1, wherein when said network band managing apparatus which is searched for receives said instruction, said network band managing apparatus searches for one of said transmission apparatus and the number of a physical port and the number of a TCP/UDP port through which said information signal is received by the transmission apparatus which is searched for, based on said subscriber identification information sent from said call control apparatus; and
wherein when said transmission apparatus which is searched for receives said instruction, said transmission apparatus extracts an information signal received by the physical port and the TCP/UDP port whose numbers are sent from said network band managing apparatus.

4. An information communication system according to claim 1, wherein each of said transmission apparatus comprises:
a network interface for receiving said instruction;
an information signal extractor for extracting an information signal which uses the physical port and the TCP/UDP port whose numbers are sent from said network band managing apparatus when said network interface receives said instruction; and
a monitor interface for sending the information signal extracted by said information signal extractor and said subscriber identification information to said second terminal.

5. An information communication system according to claim 4, wherein when said network interface receives said instruction, said information signal extractor extracts an information signal sent from the physical port and the TCP/UDP port whose numbers are sent from said network band managing apparatus.

6. An information communication system according to claim 4, wherein when said network interface receives said instruction, said information signal extractor extracts an information signal received by the physical port and the TCP/UDP port whose numbers are sent from said network band managing apparatus.

7. An information communication system according to claim 1, wherein said second terminal stores the subscriber identification information sand the information signal sent from said transmission apparatus in association with each other.

8. An information communication system according to claim 1, wherein said second terminal displays the subscriber identification information sent from said transmission apparatus and reproduces the information signal sent from said transmission apparatus.

9. An information communication system according to claim 1, wherein said first terminal and said second terminal comprise the same terminal.

10. A network band managing apparatus connected to a plurality of transmission apparatus for sending and receiving an information signal sent from a subscriber terminal carried by a subscriber using a physical port and a TCP/UDP port, for managing the band of said information signal and indicating the number of said physical port and the number of said TCP/UDP port to said transmission apparatus;
wherein when said network band managing apparatus receives an instruction to monitor said information signal from a call control apparatus connected to said network band managing apparatus, said network band managing apparatus searches for one of said transmission apparatus and the number of a physical port and the number of a TCP/UDP port used by said information signal, based on subscriber identification information sent from said call control apparatus for identifying said subscriber terminal, and sends said instruction, said subscriber identification information, and the number of the physical port and the number of the TCP/UDP port which are searched for to the transmission apparatus which is searched for.

11. A network band managing apparatus according to claim 10, wherein when said network band managing apparatus receives said instruction, said network band managing apparatus searches for one of said transmission apparatus and the number of a physical port and the number of a TCP/UDP port through which said information signal is sent from the transmission apparatus which is searched for, based on said subscriber identification information sent from said call control apparatus.

12. A network band managing apparatus according to claim 10, wherein when said network band managing apparatus which is searched for receives said instruction, said network band managing apparatus searches for one of said transmission apparatus and the number of a physical port and the number of a TCP/UDP port through which said information signal is received by the transmission apparatus which is searched for, based on said subscriber identification information sent from said call control apparatus.

13. A transmission apparatus connected to a subscriber terminal carried by a subscriber, for sending and receiving an information signal sent from the subscriber terminal using a physical port and a TCP/UDP port;
wherein when said transmission apparatus receives an instruction to monitor said information signal from a network band managing apparatus connected to said transmission apparatus, said transmission apparatus extracts an information signal which uses the physical port and the TCP/UDP port whose numbers are sent from said network band managing apparatus, and sends the extracted information signal and subscriber identification information sent from said network band managing apparatus for identifying said subscriber terminal to a terminal connected to said transmission apparatus.

14. A transmission apparatus according to claim 13, wherein when said transmission apparatus receives said instruction, said transmission apparatus extracts an information signal sent from the physical port and the TCP/UDP port whose numbers are sent from said network band managing apparatus.

15. A transmission apparatus according to claim 13, wherein when said transmission apparatus receives said instruction, said transmission apparatus extracts an information signal received by the physical port and the TCP/UDP port whose numbers are sent from said network band managing apparatus.

16. A transmission apparatus according to claim 13, comprising:
a network interface for receiving said instruction;
an information signal extractor for extracting an information signal which uses the physical port and the TCP/UDP port whose numbers are sent from said network band managing apparatus when said network interface receives said instruction; and
a monitor interface for sending the information signal extracted by said information signal extractor and subscriber identification information sent from said network band managing apparatus for identifying said subscriber terminal to a terminal connected to said transmission apparatus.

17. A transmission apparatus according to claim 16, wherein when said network interface receives said instruction, said information signal extractor extracts an information signal sent from the physical port and the TCP/UDP port whose numbers are sent from said network band managing apparatus.

18. A transmission apparatus according to claim 16, wherein when said network interface receives said instruction, said information signal extractor extracts an information signal received by the physical port and the TCP/UDP port whose numbers are sent from said network band managing apparatus.

19. A method of monitoring an information signal in an information communication system including a plurality of transmission apparatus connected to a subscriber terminal carried by a subscriber, for sending and receiving an information signal sent from the subscriber terminal using a physical port and a TCP/UDP port, a plurality of network band managing apparatus connected to said transmission apparatus, for managing the band of said information signal and indicating the number of said physical port and the number of said TCP/UDP port to said transmission apparatus, a plurality of call control apparatus connected to said network band managing apparatus, for establishing a call according to a call control signal sent from said subscriber terminal, and a plurality of subscriber information storage apparatus connected to said call control apparatus, for storing subscriber identification information for identifying said subscriber terminal and contents of services to be provided to said subscriber terminal, said call control signal and said information signal passing through different routes, wherein said method comprises the steps:
wherein when said subscriber information storage apparatus receives an instruction to monitor said information signal from a first terminal connected to said subscriber information storage apparatus, said subscriber information storage apparatus searches for one of said call control apparatus based on said subscriber identification information sent from said first terminal for identifying the subscriber terminal to be monitored;
wherein said subscriber information storage apparatus sends said instruction and said subscriber identification information to the call control apparatus which is searched for;
wherein when said call control apparatus which is searched for receives said instruction, said call control apparatus searches for one of said network band managing apparatus based on said subscriber identification information sent from said subscriber information storage apparatus;
wherein said call control apparatus sends said instruction and said subscriber identification information to the network band managing apparatus which is searched for;
wherein when said network band managing apparatus which is searched for receives said instruction, said network band managing apparatus searches for one of said transmission apparatus and the number of a physical port and the number of a TCP/UDP port used by said information signal, based on said subscriber identification information sent from said call control apparatus;
wherein said network band managing apparatus sends said instruction, said subscriber identification information, and the number of the physical port and the number of the TCP/UDP port which are searched for to the transmission apparatus which is searched for;
wherein when said transmission apparatus which is searched for receives said instruction, said transmission apparatus extracts an information signal which uses the physical port and the TCP/UDP port whose numbers are sent from said network band managing apparatus; and
wherein said transmission apparatus sends the extracted information signal and said subscriber identification information to a second terminal connected to said transmission apparatus.

20. A method according to claim 19, further comprising the steps:
wherein when said network band managing apparatus which is searched for receives said instruction, said network band managing apparatus searches for one of said transmission apparatus and the number of a physical port and the number of a TCP/UDP port through which said information signal is sent from the transmission apparatus which is searched for, based on said subscriber identification information sent from said call control apparatus; and
wherein when said transmission apparatus which is searched for receives said instruction, said transmission apparatus extracts an information signal sent from the physical port and the TCP/UDP port whose numbers are sent from said network band managing apparatus.

21. A method according to claim 19, further comprising the steps:
wherein when said network band managing apparatus which is searched for receives said instruction, said network band managing apparatus searches for one of said transmission apparatus and the number of a physical port and the number of a TCP/UDP port through which said information signal is received by the transmission apparatus which is searched for, based on said subscriber identification information sent from said call control apparatus; and
wherein when said transmission apparatus which is searched for receives said instruction, said transmission apparatus extracts an information signal received by the physical port and the TCP/UDP port whose numbers are sent from said network band managing apparatus.

22. A method according to claim 19, further comprising the step:
wherein said second terminal stores the subscriber identification information sand the information signal sent from said transmission apparatus in association with each other.

23. A method according to claim 19, further comprising the step:
wherein said second terminal displays the subscriber identification information sent from said transmission apparatus and reproduces the information signal sent from said transmission apparatus.

24. A recording medium storing therein a program for enabling a network band managing apparatus connected to a plurality of transmission apparatus for sending and receiving an information signal sent from a subscriber terminal carried by a subscriber using a physical port and a TCP/UDP port, for managing the band of said information signal and indicating the number of said physical port and the number of said TCP/UDP port to said transmission apparatus, to perform:
a process for, when an instruction to monitor said information signal is received from a call control apparatus connected to said network band managing apparatus, searching for one of said transmission apparatus and the number of a physical port and the number of a TCP/UDP port used by said information signal, based on subscriber identification information sent from said call control apparatus for identifying said subscriber terminal; and
a process for sending said instruction, said subscriber identification information, and the number of the physical port and the number of the TCP/UDP port which are searched for to the transmission apparatus which is searched for.

25. A recording medium according to claim 24, storing therein a program for further enabling said network band managing apparatus to perform:
a process for, when said instruction is received, searching for one of said transmission apparatus and the number of a physical port and the number of a TCP/UDP port through which said information signal is sent from the transmission apparatus which is searched for, based on said subscriber identification information sent from said call control apparatus.

26. A recording medium according to claim 24, storing therein a program for further enabling said network band managing apparatus to perform:
a process for, when said instruction is received, searching for one of said transmission apparatus and the number of a physical port and the number of a TCP/UDP port through which said information signal is received by the transmission apparatus which is searched for, based on said subscriber identification information sent from said call control apparatus.

27. A recording medium storing therein a program for enabling a transmission apparatus connected to a subscriber terminal carried by a subscriber, for sending and receiving an information signal sent from the subscriber terminal using a physical port and a TCP/UDP port, to perform:
a process for, when an instruction to monitor said information signal is received from a network band managing apparatus connected to said transmission apparatus, extracting an information signal which uses the physical port and the TCP/UDP port whose numbers are sent from said network band managing apparatus; and
a process for sending the extracted information signal and subscriber identification information sent from said network band managing apparatus for identifying said subscriber terminal to a terminal connected to said transmission apparatus.

28. A recording medium according to claim 27, storing therein a program for further enabling said transmission apparatus to perform:
a process for, when said instruction is received, extracting an information signal sent from the physical port and the TCP/UDP port whose numbers are sent from said network band managing apparatus.

29. A recording medium according to claim 27, storing therein a program for further enabling said transmission apparatus to perform:
a process for, when said instruction is received, extracting an information signal received by the physical port and the TCP/UDP port whose numbers are sent from said network band managing apparatus.
